(19) United States
(12) Patent Application Publication
(10) Pub. No.: US 2005/0213602 A1
(43) Pub. Date: Sep. 29, 2005

(54) Methods for providing prioritized communications using a carrier sense multiple access protocol

(75) Inventor: Jason Keith Redi, Belmont, MA (US)

Correspondence Address: FISH & NEAVE IP GROUP;ROPES & GRAY LLP, ONE INTERNATIONAL PLACE, BOSTON, MA, 02110-2624, US

(73) Assignee: BBNT Solutions LLC, Cambridge, MA (US)

(21) Appl. No.: 11/088,431

(22) Filed: Mar. 24, 2005

Related U.S. Application Data
(60) Provisional application No. 60/556,124, filed on Mar. 25, 2004.

(51) Int. Cl. H04L 12/413

(52) U.S. Cl. 370/445

(57) ABSTRACT

A method of communication is provided in which a node maintains a condition table which includes at least one condition unrelated to network traffic conditions, which if met triggers the node to reserve a set of time windows for receiving communications. During those time windows, the node refrains from initiating transmission of communication.

### CROSS REFERENCE TO RELATED APPLICATIONS

The instant application claims priority from provisional application No. 60/556,124, filed Mar. 25, 2004, the disclosure of which is incorporated herein by reference in its entirety.

### STATEMENT REGARDING FEDERALLY SPONSORED RESEARCH OR DEVELOPMENT

This invention was made with Government support under Contract No. W911NF-04-C-0025, awarded by DARPA ATO. The Government has certain rights in this invention

### FIELD OF THE INVENTION

The application relates in general to ad hoc computer networking, and more particularly, in various embodiments, to improve Carrier Sense Multiple Access (CSMA) protocols to provide for prioritized communication.

### BACKGROUND

One common protocol used in computer networking is the CSMA protocol. One version, CSMA/CD is often used in wireless networks. According to the CSMA protocol, communication nodes reserve time on a channel, typically on a first-come, first-serve basis. Each node waits a random period of a time after a channel clears before attempting to transmit its next data packet. The node with the shortest random wait time reserves the channel and is able to transmit. The random waiting, however, can leave some nodes with insufficient access to the channel to transmit higher priority data.

In another frequently used protocol, the Time Division Multiple Access (TDMA) protocol, each node is assigned a periodic time slot in which it can transmit data. While this protocol ensures a minimum bandwidth to each node, substantial bandwidth can be wasted if one node is responsible for transmitting much of the data traffic in the network.

### SUMMARY

A new protocol, referred to herein as the priorityCSMA protocol combines benefits of the TDMA and CSMA protocols to provide at least minimum bandwidth for priority messaging while still reducing the likelihood of wasted bandwidth. In a first embodiment, a node utilizing the priorityCSMA protocol maintains a condition table. The condition table includes at least one condition unrelated to network traffic conditions, which if met, triggers the node to reserve a set of time windows for receiving communications. During those time windows, the node refrains from initiating transmission of communication.

The node incorporates the set of time windows into a reservation table, which also keeps track of standard CSMA traffic-related time windows in which the node refrains from initiating communication. In one embodiment, subsequent to the time windows unrelated to network traffic being incorporated into the reservation table, the node determines whether it can transmit data, or whether it must refrain from such transmission, just as if it were using a standard CSMA protocol.

In general, a node incorporates the time windows unrelated to network traffic conditions in response to detecting that a traffic-independent condition is met. A node can store multiple sets of such time windows corresponding to different traffic-independent conditions. For example, the node may incorporate time windows into its reservation table in response to determining that the node is within a predetermined location. The predetermined location may be a fixed geographic location or a relative location, for example, within a kilometer of a second node, which may itself be mobile. In another example, the node incorporates time windows into its reservation table in exchange for gaining access to network services. Alternatively, or in addition, the node incorporates time windows into its reservation table upon the instruction or request of another node.

In another embodiment of the priority CSMA protocol, the time windows unrelated to network traffic conditions have corresponding classes. In this embodiment, nodes in such a time window refrain from initiating transmission of data unless the data belongs to the class that corresponds to the time window. Example classes include, without limitation, multicast data, high priority data, data originating from another specific node or group of nodes.

### BRIEF DESCRIPTION OF THE DRAWINGS

The invention may be better understood from the following illustrative description with reference to the following drawings.

FIG. 1 is a conceptual diagram of a network in which illustrative embodiments of the invention operate;

FIG. 2 is a conceptual block diagram of a node operating on the network depicted in FIG. 1, according to an illustrative embodiment of the invention.

FIG. 3 is a conceptual diagram of a reservation table for reserving time during which the node refrains from transmission initiation, according to an illustrative embodimentof the invention;

FIG. 4 is a flowchart of a method of data packet transmission known in the prior art which can be used in conjunction with illustrative embodiments of the invention;

FIG. 5 is a flowchart of a method of populating a reservation table as described in FIG. 3 with network traffic independent reservation time windows according to an illustrative embodiment of the invention;

FIG. 6 is a flowchart of a second method of populating a reservation table as described in FIG. 3 with network traffic independent reservation time windows based on node location according to an illustrative embodiment of the invention;

FIG. 7 is a flowchart of a method of populating a reservation table as described in FIG. 2 with network traffic independent reservation time windows based on network service access according to an illustrative embodiment of the invention;

FIG. 8 is a flowchart of an illustrative method of transmitting packets based on packet class reservations stored in a reservation table as a result of any of the methods described in FIGS. 4-6.

### DESCRIPTION OF AN ILLUSTRATIVE EMBODIMENT

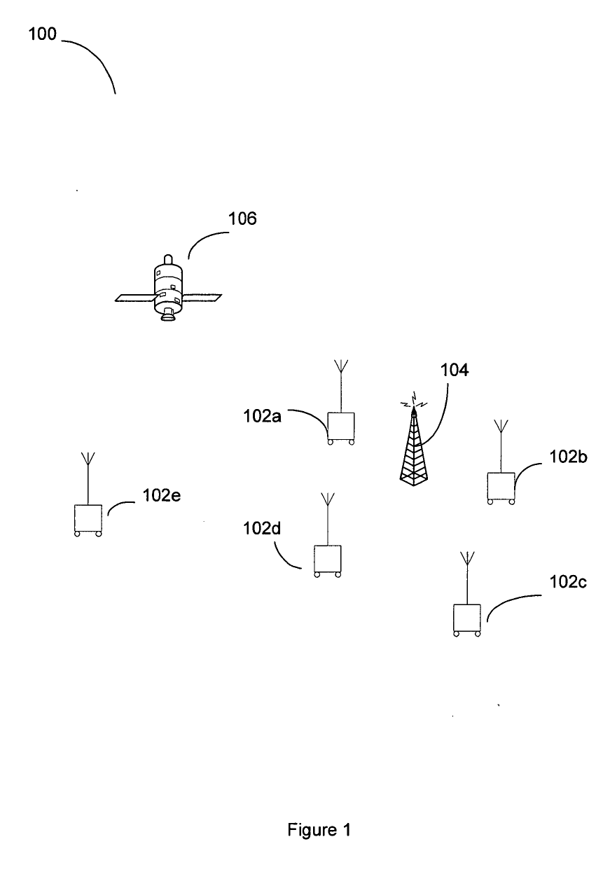

FIG. 1 is a conceptual diagram of a network 100 in which nodes communicate according to a priority CSMA protocol according to an illustrative embodiment of the invention. The network 100 includes a plurality of wireless nodes 102a-102e (generally referred to as “nodes 102”) and a base station 104. The base station 104 communicates with the plurality of nodes 102a-102e wirelessly. The base station 104 preferably is fixed in location. The base station 104 may communicate with other nodes 102a-102e and other networks using a combination of wired and wireless methods. The network 100 also includes a global positioning satellite 106 for transmitting position signals to the nodes 102a-102e.

Wireless nodes can use a number of protocols for communication. One common protocol is the Carrier Sense Multiple Access (CSMA) protocol. In a typical CSMA protocol, a transmitting node, for example, a node 102a, listens to a communication channel to determine whether the communication channel is clear for the transmitting node 102a to transmit a data message. If the channel is clear, the transmitting node 102a transmits a request to send (RTS) message to a destination node, for example, 102b. The RTS message includes a data field indicating the time the transmitting node 102a expects the transmission to take. The destination node 102b receives the RTS message, and if the no other node 102 is transmitting a message to the destination node 102b, the destination node 102b transmits a clear to send (CTS) message, indicating to the transmitting node 102a that it can begin transmission.

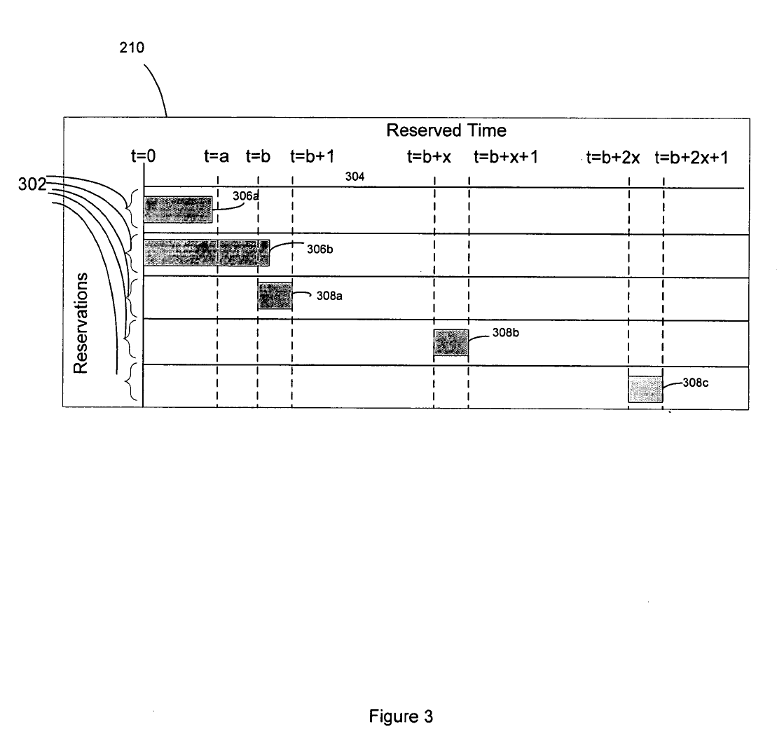

In wireless CSMA networks, the RTS and CTS messages are broadcast such that all nodes 102 within radio range (also known as neighbors) of the transmitting 102a and destination 102b nodes receive the messages. The neighbors record the time at which they receive the RTS and CTS messages, along with the expected duration of the corresponding transmission indicated in the RTS and CTS messages. Based on this information, the neighbors predict a future time that the channel is next going to be available for transmission. According to the protocol, the time period between the transmission of the CTS and the expected end of a transmission defines a time window during which neighboring nodes are to refrain from initiating transmissions of their own. Illustratively, these time windows are stored in a reservation table, also known as a network allocation vector (NAV) table. An enhanced reservation table, suitable for illustrative embodiments of the invention, is discussed further in relation to FIG. 3.

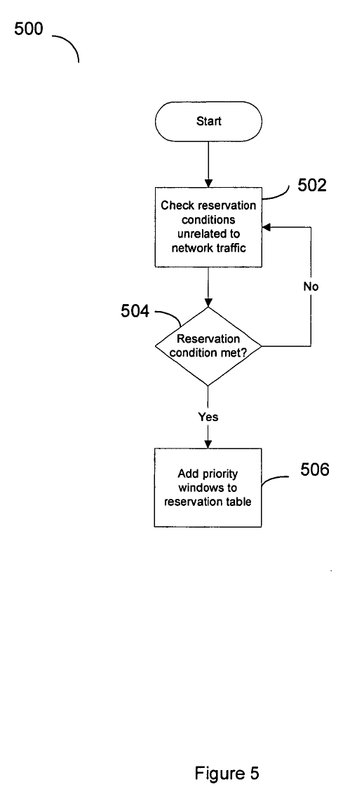

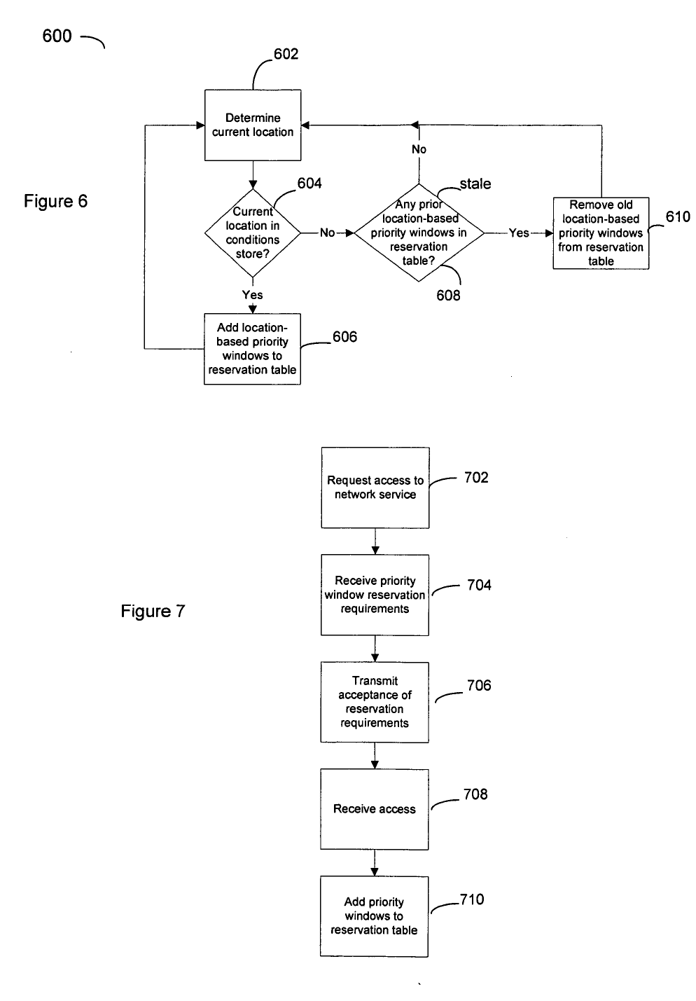

According to the illustrative embodiment of the invention, the nodes 102 communicate according to a modified CSMA protocol, referred to herein as the priorityCSMA protocol. In addition to nodes 102 refraining from initiating transmissions based on receipt of RTS and CTS messages, or other network traffic related conditions, the nodes 102 operating according to the priorityCSMA protocol reserve additional time windows for ensuring another node 102 or the base station 104 has the ability to transmit data packets. These additional time windows are referred to herein as priority windows. Nodes 102 reserve the priority windows based on conditions which are unrelated to current network traffic. For example, the nodes 102 may reserve priority windows based on location (for example, see FIG. 5 below). The nodes 102 may also reserve priority windows in exchange for provision of network services (for example, see FIG. 6 below). During these priority windows, the nodes 102 refrain from initiating transmissions in the same fashion as if the time windows were reserved based on receiving RTS and CTS messages, even if the channel is clear during the priority window.

The nodes 102a-102e communicate with one another via an ad hoc network. Example devices suitable for serving as nodes 102 for the purposes of the invention include desktop computers, laptop computers, personal data assistants, mobile telephones, and other computing devices having wireless communication capabilities. Preferably, the nodes 102 are portable or mobile.

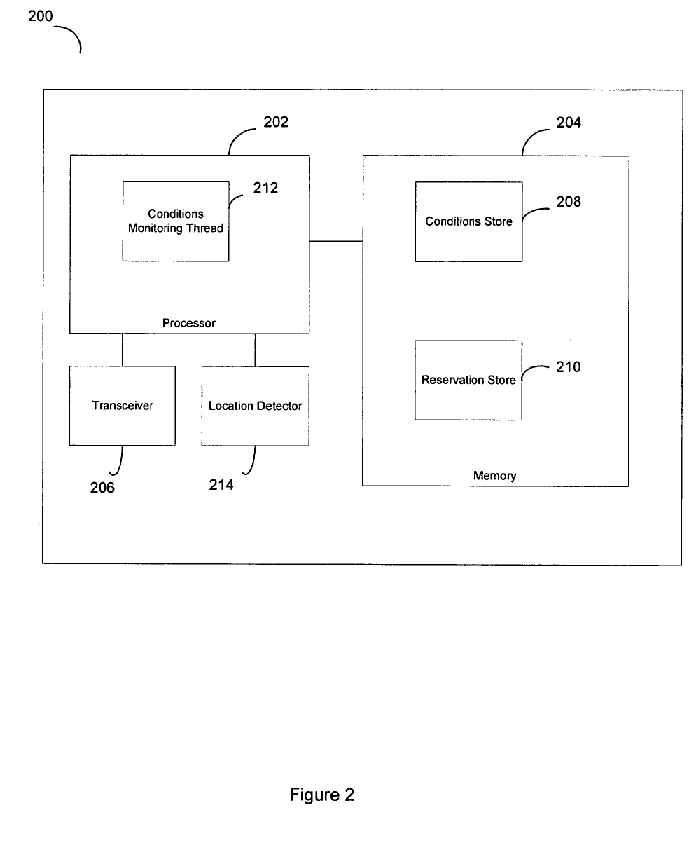

FIG. 2 is a conceptual block diagram of a node 200, such as node 102a depicted in FIG. 1, operating according to the priroityCSMA protocol according to an illustrative embodiment of the invention. The node 200 in includes a processor 202, a memory 204, and a transceiver 206. The processor 202 an be a general or special purpose computer processor, a digital signal processor, an application specific integrated circuit, or other integrated circuit, or a combination thereof. The processor 202 evaluates non-network-traffic related conditions and controls the transmission and receipt of data by the transceiver 206. The transceiver 206 can be any wireless transceiver known in the art for wireless digital communication. The memory 204 includes a conditions store 208 and a reservation table 210. The conditions store 208 includes one or more conditions unrelated to network traffic and a set of priority time windows corresponding to each condition. The node 200 may include a condition monitoring thread 212, discussed further in relation to FIG. 5, and/or a location detector 214, discussed further in relation to FIG. 6.

FIG. 3 is a conceptual diagram of the reservation table 210 of the node 200 depicted in FIG. 2, according to an illustrative embodiment of the invention. In the reservation table 210, each row 302 corresponds to a separate reserved time window. The reservation table includes both traffic-related time windows 306a and 306b (generally referred to as “traffic-related time windows 306”) and priority windows 308a-308c (generally referred to as “priority windows 308”). The horizontal axis 304 corresponds to time.

The reservation table 210 includes two traffic based time windows 306a and 306b reserved at time t=0 (i.e., the present). The reservation table 210 may incorporate multiple traffic-related time windows 306 corresponding a single point in time. The overlapping time windows 306 result from transmissions being sent by two different neighbors that are each in radio range of the node 200, but which are not in range of one another. The first time window 306a in the reservation table 210 expires at time t=a, and the second window 306b expires at time t=b+δ.

The reservation table 210 also includes three priority windows 308a-308c. The priority windows 308a-308c in the illustrated reservation table 210 occur periodically. Each priority window 308a-308c lasts, for example, for 1 unit of time. The first priority window 308a begins at time t=b and ends at time t=b+1. The second priority window 308b begins at time t=b+x and ends at time t=b+x+1. The third priority window 308c begins at time t=b+2× and ends at time t=b+2x+1. Thus, based on the current status of the reservation table 210, the node 200 is permitted to attempting initiating transmission of data between times t=b+1 and t=b+x, between times t=b+x+1 and t=b+2×, and after time t=b+2x+1.

Note that the second traffic-based time window 306b partially overlaps with the first priority window 308a. This indicates that a second node, such as node 102b, will be transmitting during at least part of the first priority window 308a. It this implementation of the priorityCSMA protocol, the continuation of transmission into a priority window 308 is allowed, though such allowance is not essential. The priorityCSMA protocol prohibits the initiation of new transmissions during time windows 306 or 308 in the reservation table 210. That is, a priority window 308 is treated just like traffic related time windows 306 incorporated into the reservation table 210.

While only one set of priority windows 308 is depicted in the reservation table 210, the reservation table 210 may incorporate multiple sets of priority windows 308 corresponding to different classes of priority transmissions. Example priority transmission classes include, without limitation, multicast communications, transmissions originating from the base station 104, transmissions originating from a specific one, or group, of the other nodes 102, etc. The reservation table 210, however, in this implementation, need not keep track of the class of a priority window 308, or the fact that the priority window 308 is a priority window 308 at all.

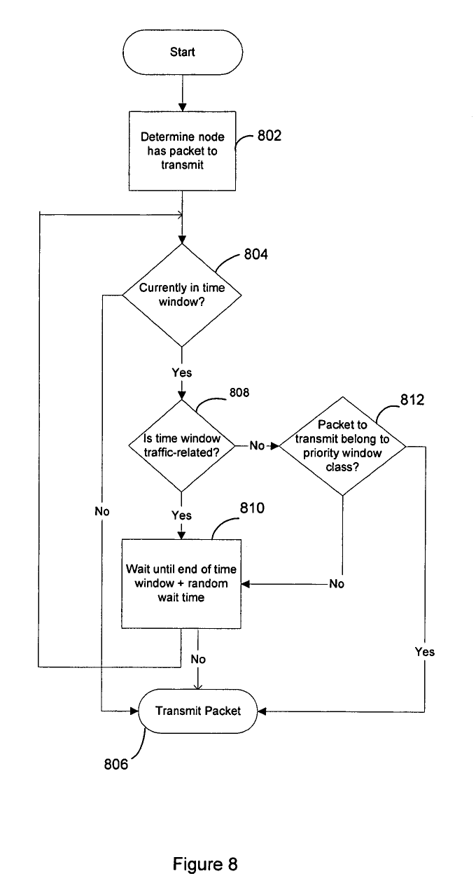

In an alternative implementation of the priorityCSMA protocol, referred to herein as the priorityCSMA-b protocol, described further in relation to FIG. 8, the reservation table 210 and node 200 differentiate treatment of traffic-related time windows 306 and priority windows 308 of different classes.

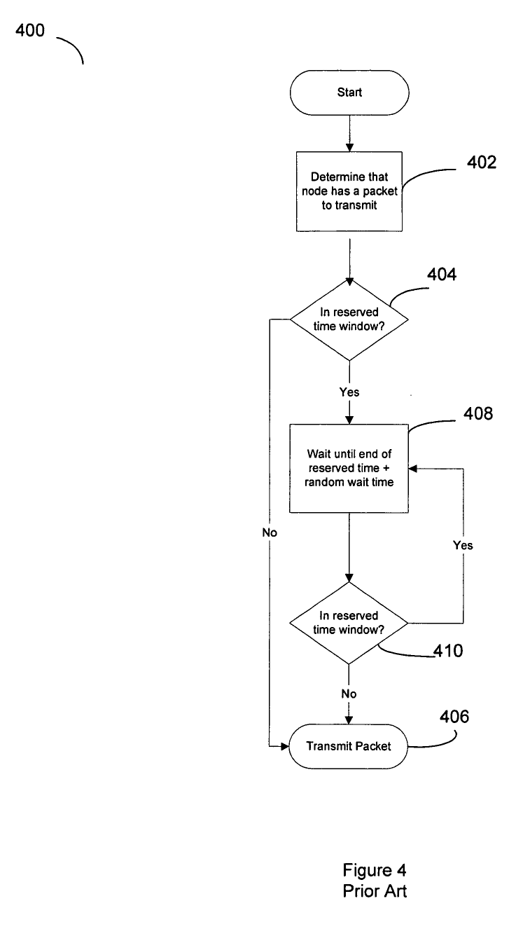

FIG. 4 is a flowchart of a method 400 of a CSMA data packet transmission known in the prior art, which can be used in conjunction with illustrative embodiments of the invention. As indicated above, the nodes 102 using the priorityCSMA protocol treat priority windows 308 no differently from traffic-related time windows 306. Thus, the nodes 102 are able to use standard CSMA transmission methods. With respect to node 200, the transmission process 400 begins with the node 200 determining that it has a data packet to transmit (step 402). The node 200 then checks its reservation table 210 to determine if it is in a time window 306 or 308 in which it is to refrain from initiating transmission of the data packet (decision block 404). If the reservation table 210 indicates that the node 200 is not in such a time window 306 or 308, the node 200 initiates transmission of the data packet (step 406).

If the reservation table 210 indicates that the node 200 is in a time window 306 or 308 in which the node 200 is to refrain from initiating transmissions, the node 200 waits until the end of the time window 306 or 308, as indicated by the reservation table 210, and then waits an additional random period of time (step 408). The random wait period ensures that all of the node's neighbors do not try to initiate communication at the same time, as soon as the time window 306 or 308 ends.

At the end of the random time period, the node 200 checks its reservation table 210 to determine if a new time window 306 or 308 in which it is to refrain from initiating transmission has begun (decision block 410). The node 200 ends up in a new time window 306 or 308, for example under three circumstances: 1) a neighboring node 102, which also had a data packet to transmit, waited a shorter random time period before initiating transmission of the data packet; 2) a neighboring node 102, which was not bound by the previous traffic-related time window 306, begins transmitting during the time the node 200 was waiting; and 3) the random waiting period ends in a priority time window 308. If a new time window, whether it is a priority window 308 or a traffic-related window 306, begins during the time the node 200 waits to initiate transmission, the node 200 waits until the end of the new time window 306 or 308 plus another additional random period of time (step 408).

If the reservation table 210, at the end of random waiting period, indicates that the node 200 is not in another time window 306 or 308 in which it is to refrain from initiating transmission, the node 200 initiates transmission of the data packet (step 406).

FIG. 5 is a flowchart of a generalized method 500 of populating a reservation table 210 with priority windows 308 according to an illustrative embodiment of the invention. Referring also to FIGS. 2 and 3, the node 200 maintains a conditions store 208, which includes a list of one or more sets of priority windows 308 corresponding to various traffic-independent conditions. For example, under a first condition, the node 200 reserves the first millisecond of every second as a priority window 308. Under a second condition, the node 200 reserves the fifth through seventh milliseconds of every second as a priority window 308. More than one condition can be met at any given time, in which case the node 200 reserves multiple sets of priority windows 308.

Periodically, the node 200 checks if any of the conditions in the conditions store 208 are met (step 502). If, at decision block 504, the node 200 determines that one such condition is met, the node 200 adds the priority windows 308 corresponding to that condition to its reservation table 210 (step 506). If none of the conditions are met, the node 200 waits a predetermined period of time and rechecks the conditions (step 502).

Referring back to FIG. 2, in an alternative implementation, the node 200 executes a separate condition monitoring thread 212, which operates in the background on the processor 202. The condition monitoring thread 212 continuously monitors the stored conditions (step 502). If the condition monitoring thread 212 determines that a stored condition is met at decision block 504, the condition monitoring thread 212 issues an interrupt command to add corresponding priority windows 308 to the reservation table 210 (step 506).

FIG. 6 is a flowchart of one particular method 600 of incorporating priority windows 308 into the reservation table 210 of node 200, according to an illustrative embodiment of the invention. The method 600 incorporates priority windows 308 into the reservation table 210 based on the location of the node 200.

The conditions store 208 of the node 200, in this case, stores data identifying at least one location, such as an area surrounding the base station 104. If the node 200 enters one of the locations identified in the conditions store 208, the node 200 adds a set of priority windows 308 to its reservation table 210. Reserving priority windows 308 based on location helps ensure that traffic particular to a given area has the opportunity to be transmitted. For example, in a municipal setting, a municipality may want to ensure that emergency responders, such as police officers, firefighters, and emergency medical personnel have sufficient bandwidth to communicate. To this end, nodes 102 operated by non-emergency responders may be required to reserve priority windows 308 while near police stations, fire stations, and hospitals to ensure that emergency workers have some minimum access to the network 100.

In another example, in a military setting, communications may be routed through the base station 104. As a node, such as the node 102, approaches the base station 104, the node reserves priority windows 308 to allow the base station 104 a minimum amount of bandwidth to transmit routing or other multicast information.

To carry out the method 600 of location-based priority window 308 reservation, the node 200 determines its location (step 602). As mentioned in relation to FIG. 2, the node 200 may include a location detector 214, for determining the location of the node. In the illustrated network 100, the location detector 214 receives a positioning signal, for example, from the satellite 106. Alternatively, the location detector 214 can utilize any other known positioning technique suitable for determining one's location. The node 200 then compares the determined location with a list of locations in its conditions store 208 (decision block 604). If the node 200 determines it is to reserve priority windows 308 based on its current location and the conditions store 208, the node 200 adds priority windows 308 corresponding to the location to its reservation table 210 (step 606).

If the node 200 determines it is not to reserve priority windows 308 in its current location, the node 200 reviews its reservation table 210 to determine if the reservation table 210 currently incorporates any stale location-based priority windows 308 (decision block 608). Such priority windows 308 may have been added to the reservation table 210 based on the prior location of the node 200. If stale priority windows 308 exist in the reservation table 210, they are removed at this point (step 610). As the node 200 continues to move, it continues to monitor its location (step 602) to determine if it needs to add priority windows 308 to (step 606) or remove priority windows 308 from (step 610) its reservation table 210.

FIG. 7 is a flowchart of another particular method 700 of populating a reservation table 210, according to an illustrative embodiment of the invention. The method 700 incorporates priority windows 308 into the reservation table 210 of a node, such as the node 200, based on the node 200 being granted access to network services. For example, if a user of the node 200 wants to utilize the wireless network of an airport or commercial establishment, such as a mall, the wireless network can make the reservation of priority windows 308 a condition of granting access. Such priority windows 308 can be used by the wireless network to reserve bandwidth to distribute advertisements or commercial data. For a business offering wireless Internet services to visitors, the business can ensure that the visitors do not monopolize the company's bandwidth by requiring the visitors to reserve priority windows 308. During the priority windows 308, company employees do not have to compete with visitors for bandwidth.

The method 700 begins with the node 200 requesting access to a network service (step 702). The node 200 then receives priority window 308 reservation requirements (step 704), which the node 200 must accept to gain access to the requested network services. Assuming the node 200 is willing to accept the reservation requirements, the node 200 transmits an acceptance message (step 706) indicating it will reserve the required priority windows 308. The node 200 is given the requested access (step 708) and the node 200 adds the required priority windows 308 to its reservation table 210 (step 710).

The methods illustrated in FIGS. 5 and 6 are only examples of methods of adding priority windows to node's reservation table. Other conditions besides location and network service access rights, including without limitation, the time of day, mutual agreement between nodes 102, or the receipt of a priority window 308 reservation request or instruction, can be used as conditions for adding priority windows 308 to a reservation table 210.
Alternative Implementation−PriorityCSMA-b

As mentioned above, in another illustrative implementation of priorityCSMA (priorityCSMA-b), the node 200 differentiates between the priority windows 308 based on a class of data transmission that corresponds to a given priority window 308. In priorityCSMA-b, the limitation on initiating communications during a priority window 308 is not a prohibition on transmission initiation. Instead, priorityCSMA-b limits the class of data transmissions that can be initiated during a priority window 308.

FIG. 8 is a flowchart of an illustrative method 800 for transmitting data packets based on data class priority window 308 reservations, according to an illustrative embodiment of the invention. Such priority windows 308 are incorporated into the reservation table 210 of the node 200 in response to the node 200 detecting conditions unrelated to network traffic. For example, the node 200 may have incorporated the priority windows 308 according to any of the methods described in relation to FIGS. 4-6.

The method 800 begins with the node 200 determining that it has a data packet to transmit (step 802). The node 200 then checks its reservation table 210 to determine if it is in a time window 306 or 308 during which it limits the initiation of data transmissions (decision block 804). If the node 200 is not in such a time window 306 or 308, the node 200 initiates transmission of the data packet (step 806).

If the node 200 is in a time window 306 or 308 during which it limits initiation of transmissions, the node 200 determines whether the time window 306 or 308 is related to network traffic (i.e., the channel is currently being used by other nodes), or whether the time window is a priority window 308 (decision block 808). If the time window 306 or 308 is related to network traffic, the node 200 waits until the end of the traffic-related time window 306 and another random period of time, thereafter (step 810). After the waiting period, the node 200 checks its reservation table 210 again to see if it is clear to transmit its data packet (decision block 804).

If the node 200 instead determines that it is in a priority window 308, the node 200 compares the class of the priority window 308 with the class of the data packet the node is attempting to transmit (decision block 812). If the data packet belongs to the priority window 308 class, the node 200 initiates transmission of the data packet (step 806). Otherwise, the node 200 waits until the end of the time window and an additional random time period thereafter (step 810) before attempting to reinitiate transmission at decision block 804.

The invention may be embodied in other specific forms without departing form the spirit or essential characteristics thereof. The forgoing embodiments are therefore to be considered in all respects illustrative, rather than limiting of the invention.

1. A method of communicating according to a Carrier Sense Multiple Access protocol, the method comprising:
based on previously stored conditions unrelated to network traffic, determining at a node whether to reserve a set of time windows for receiving communications;
in response to determining that the node is to reserve the set of time windows, incorporating the set of time windows into a reservation for the node;
refraining at the node from initiating transmissions of data during the set of time windows.

2. The method of claim 1 including selecting the set of time windows from a predetermined plurality of sets of time windows.

3. The method of claim 2 wherein each of the predetermined plurality of sets of time windows corresponds to a corresponding condition unrelated to network traffic.

4. The method of claim 1, wherein the node determines to reserve the set of time windows based on being granted access to a network.

5. The method of claim 1, wherein the node determines to reserve the set of time windows based on an entrance to a predetermined geographic location.

6. The method of claim 1, wherein the node determines to reserve the set of time windows based on an entrance to a predetermined position in relation to a second node.

7. The method of claim 1, wherein the node determines to reserve the set of time windows based on reaching a predetermined position in relation to a mobile object.

8. The method of claim 1, comprising receiving instructions from a second node to reserve a second set of time windows for reception, independent of network traffic conditions.

9. A method of communicating in a network according to a Carrier Sense Multiple Access protocol, the method comprising:
maintaining a reservation tables including time windows during which a node of the network limits initiation of data transmissions based on a class of the data transmissions;
determining by the node that it has a data packet to transmit;
determining by the node from the reservation table if it is in one of the time windows during which the node limits the initiation of data transmission;
in response to the node determining that it is in such a time window, refraining, at the node, from initiating transmission of the data packet unless the data packet belongs to the class of data that corresponds to the time window the node is in.

10. The method of claim 9, wherein the class of data transmissions includes high-priority data packets.

11. The method of claim 7, wherein the class of data transmissions includes multicast data packets.

12. The method of claim 7, wherein the class of data transmissions includes data packets originating from a second node.

13. The method claim 7, wherein initiating transmission of the data packet includes determining if a communication channel is clear of traffic.
